(19) United States
(12) Patent Application Publication
(10) Pub. No.: US 2022/0283774 A1
(43) Pub. Date: Sep. 8, 2022

(54) SYSTEMS AND METHODS FOR NOISE FIELD MAPPING USING BEAMFORMING MICROPHONE ARRAY

(71) Applicant: Shure Acquisition Holdings, Inc., Niles, IL (US)

(72) Inventor: Jordan Schultz, Chicago, IL (US)

(21) Appl. No.: 17/667,356

(22) Filed: Feb. 8, 2022

Related U.S. Application Data
(63) Continuation of application No. 63/156,044, filed on Mar. 3, 2021.

(51) Int. Cl. G06F 3/16; H04R 1/40; G10K 11/178

(52) U.S. Cl. CPC G06F 3/165; H04R 1/406; G10K 11/178

(57) ABSTRACT

Systems and methods configured to employ a beamforming microphone array to determine a noise field map of a conferencing environment and modify operation of the beamforming microphone array responsive to the determined noise field map.

### CROSS-REFERENCE

This application claims the benefit of and priority to U.S. Provisional Patent Application No. 63/156,044, filed on Mar. 3, 2021, the contents of which are incorporated herein by reference in their entirety.

### TECHNICAL FIELD

This application generally relates to systems and methods configured to employ a beamforming microphone array to determine a noise field map of a conferencing environment and modify operation of the beamforming microphone array responsive to the determined noise field map.

### BACKGROUND

Conferencing environments (e.g., conference rooms, boardrooms, huddle rooms, and video conferencing settings), can involve the use of transducers, such as microphones, for capturing sound from various audio sources active in such environments. For example, microphones may be placed on a table or lectern near one or more audio sources and/or may be mounted overhead to capture the sound from a larger area, such as an entire room. Conferencing environments can also involve one or more speakers to disseminate the captured sound to a local audience. For example, loudspeakers may be placed on a wall or ceiling to emit sound to listeners in the environment.

Traditional microphones typically have fixed polar patterns and few manually selectable settings. To capture sound in an environment, many traditional microphones can be used at once to capture the audio sources within the environment. However, traditional microphones tend to capture unwanted audio as well, such as room noise, echoes, and other undesirable audio elements. The capturing of these unwanted noises is exacerbated by the use of many microphones.

Microphone array systems having multiple microphone elements that can provide benefits such as steerable coverage or pick up patterns (having one or more lobes and/or nulls), which enable the microphone elements to focus on the desired audio sources. However, the initial and ongoing configuration and control of the lobes and nulls of such microphone array systems in certain physical environments can be complex, time consuming and not appropriately account for areas of elevated noise. Additionally, even after the initial configuration is completed, the conferencing environment may change, such as via the introduction and/or movement of sources of unwanted background noise. For example, audio sources (e.g., speakers) and/or objects in the environment may move or have been moved since the initial configuration was completed. In this scenario, the microphones may not optimally capture sound in the environment. As such, despite microphones with various features being available, certain challenges remain regarding ambient background noise in such conferencing environments.

One particular challenge relates to speech intelligibility wherein a speaker's speech is masked by ambient background noise in the conferencing environment. For example, different noise sources, such as the fans of electronic components installed after the initial configuration of the lobes and nulls of an installed microphone array, located in the physical space of a conferencing environment often produce unwanted noise that diminish listeners' ability to clearly hear a speaker speak, potentially resulting in misunderstandings, frustration and/or loss of interest by communication partners. Moreover, since the noise produced by such noise sources can be diffuse and/or directional and the directional information of a specific sound source is often lost due to reverberation effects in a room, prior attempts to account for the source of such ambient background noise have not eliminated such unwanted noise. Given these limitations to combating unwanted ambient background noise in a conferencing environment, there is a need for a system that identifies areas of elevated noise agnostic of noise source location and then employs one or more sound treatments, such as digital signal processing techniques, to account for the elevated noise at the identified location.

### SUMMARY

In certain embodiments, the present disclosure relates to a method of operating an audio system including determining, by a first audio device, an area of a room associated with an amount of noise satisfying a criteria, and characterizing a noise of the determined area of the room. The method also includes modifying, based on the characterization of the noise of the determined area of the room, an operation of a component of a second audio device associated with the determined area of the room.

In certain embodiments, the present disclosure relates to a method of operating an audio system including, determining a first configuration of an audio device associated with a room, and receiving data associated with a location in the room of an amount of ambient noise satisfying a criteria. The method also includes modifying, based on the received data, the first configuration of the audio device to a second, different configuration.

These and other embodiments, and various permutations and aspects, will become apparent and be more fully understood from the following detailed description and accompanying drawings, which set forth illustrative embodiments that are indicative of the various ways in which the principles of the disclosure may be employed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an exemplary depiction of a physical environment including a noise field map determining system in accordance with one or more embodiments.

FIG. 2 is an exemplary depiction of a top view of the physical environment of FIG. 1 illustrating a plurality of measurement points employed to determine a noise field map in accordance with one or more embodiments.

FIG. 3 is an example graphical user interface illustrating the determined noise field map of the physical environment of FIG. 1 in accordance with one or more embodiments.

FIG. 4 is an exemplary depiction of a top view of the physical environment of FIG. 1 overlaid with the determined noise field map of FIG. 3 and illustrating the different sound treatments applied to the identified areas of elevated noise as determined by the noise field map in accordance with one or more embodiments.

FIG. 5 is a block diagram illustrating an exemplary computing device of the audio system in accordance with one or more embodiments.

### DETAILED DESCRIPTION

The description that follows describes, illustrates and exemplifies one or more particular embodiments of the disclosure in accordance with its principles. This description is not provided to limit the disclosure to the embodiments described herein, but rather to explain and teach the principles of the disclosure in such a way to enable one of ordinary skill in the art to understand these principles and, with that understanding, be able to apply them to practice not only the embodiments described herein, but also other embodiments that may come to mind in accordance with these principles. The scope of the disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the disclosure as taught herein and understood to one of ordinary skill in the art.

In various embodiments, systems and methods are provided herein for modifying one or more aspects of one or more audio devices in a conferencing environment based on one or more identified areas of elevated noise levels in the conferencing environment. In these embodiments, following the determination of one or more areas of elevated noise levels in a conferencing environment, the systems and methods of this disclosure account for such a determination in altering the operation of one or more audio devices, such as altering how one or more audio devices capture sound, altering how one or more audio devices transmit sound and/or altering how one or more audio devices digitally process sound. Employing these alterations reduces the effect of unwanted noise, such as ambient background noise, in the conferencing environment thereby enhancing listeners' ability to clearly hear a speaker speak (and potentially reducing any misunderstandings, frustration and/or loss of interest by communication partners).

Specifically, in certain embodiments, the system of this disclosure utilizes one or more audio devices to generate one or more noise field maps (i.e., a set of measurements that follow the dimensions of a conferencing environment to locate areas of elevated stationary noise levels agnostic of a location of the source of such noise). In these embodiments, the system then utilizes such noise field maps to modify the operation of one or more audio devices in the conferencing environment, wherein such modified audio devices may be the same audio devices used to generate the noise field map or different audio devices. For example, the system of this disclosure employs a beamforming microphone array to determine a noise field map via determining a set of acoustic measurements that follow the dimensions of a room to locate areas of elevated noise levels independent of any determination of any source of such noise. In this example, following the determination of the noise field map, the system of this disclosure utilizes the beamforming microphone array as a conferencing microphone wherein the system accounts for the determined noise field map in modifying the operation of the beamforming microphone array as a conferencing microphone (e.g., modifying the processing sound captured by the beamforming microphone array). In these embodiments, by accounting for specific areas of a conferencing environment with amounts of noise satisfying a criteria (and not trying to simply locate a source of unwanted noise), the system is operable to gain insight into areas of relatively poor intelligibility and apply preferential audio processing to such areas (via employing audio application software to treat wanted sounds and/or reduce unwanted noise) to improve a user's audio experience in the conferencing environment.

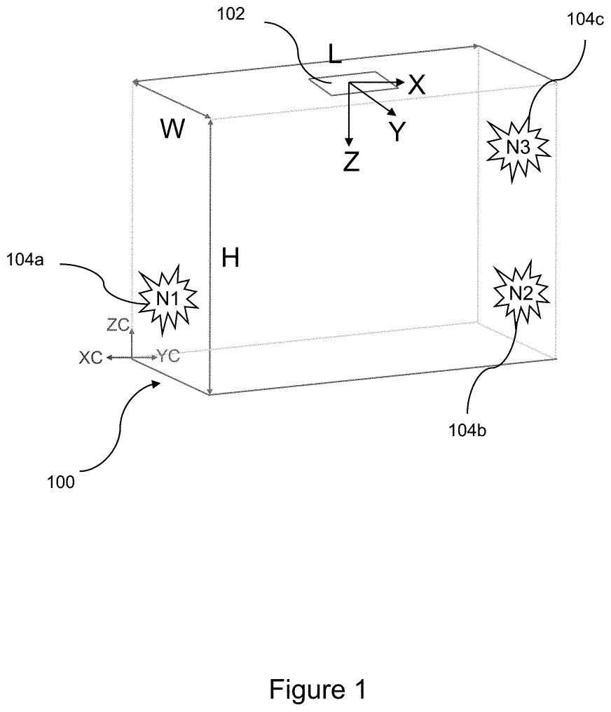

More specifically, FIG. 1 is an exemplary depiction of a physical environment 100 in which the systems and methods disclosed herein may be used. In particular, FIG. 1 shows a perspective view of an exemplary conference room including one or more components of a noise field map determining system and one or more areas of elevated noise associated with one or more noise generating objects. It should be noted that while FIG. 1 illustrates one potential environment, it should be understood that the systems and methods disclosed herein may be utilized in any applicable environment, including but not limited to offices, huddle rooms, theaters, arenas, and/or music venues.

The system in the environment 100 shown in FIG. 1 includes an audio device, such as a beamforming microphone array 102, configured to detect and capture sound, such as speech spoken by human speakers. The beamforming microphone array 102 may include any number of microphone elements, and be able to form multiple pickup patterns so that the sound from the audio sources can be detected and captured. Any appropriate number of microphone elements are possible and contemplated in the beamforming microphone array 102.

Each of the microphone elements in the beamforming microphone array 102 may detect sound and convert the sound to an analog audio signal. Components in the beamforming microphone array 102, such as analog to digital converters, processors, and/or other components, may process the analog audio signals and ultimately generate one or more digital audio output signals. The digital audio output signals may conform to the Dante standard for transmitting audio over Ethernet, in some embodiments, or may conform to another standard and/or transmission protocol. In certain embodiments, each of the microphone elements in the beamforming microphone array 102 may detect sound and convert the sound to a digital audio signal.

One or more pickup patterns may be formed by the beamforming microphone array 102 from the audio signals of the microphone elements, and a digital audio output signal may be generated corresponding to each of the pickup patterns. The pickup patterns may be composed of one or more lobes (e.g., main, side, and back lobes), and/or one or more nulls. In other embodiments, the microphone elements in the beamforming microphone array 102 may output analog audio signals so that other components and devices (e.g., processors, mixers, recorders, and/or amplifiers) external to the beamforming microphone array 102 may process the analog audio signals. In certain embodiments, higher order lobes can be synthesized from the aggregate of some or all available microphones in the system to increase overall signal to noise. In other embodiments, the selection of particular microphones in the system can gate (i.e., shut off) the sound from unwanted audio sources to increase signal to noise.

The pickup patterns that can be formed by the beamforming microphone array 102 may be dependent on the type of beamformer used with the microphone elements. For example, a delay and sum beamformer may form a frequency-dependent pickup pattern based on its filter structure and the layout geometry of the microphone elements. As another example, a differential beamformer may form a cardioid, subcardioid, supercardioid, hypercardioid, or bidirectional pickup pattern. The microphone elements may each be a MEMS (micro-electrical mechanical system) microphone with an omnidirectional pickup pattern, in some embodiments. In other embodiments, the microphone elements may have other pickup patterns and/or may be electret condenser microphones, dynamic microphones, ribbon microphones, piezoelectric microphones, and/or other types of microphones. In embodiments, the microphone elements may be arrayed in one dimension or multiple dimensions.

In addition to including an audio device, such as a beamforming microphone array, configured to detect and capture sound from one or more audio sources, such as speech spoken by human speakers, the environment 100 shown in FIG. 1 may include one or more sound generating devices, such as loudspeakers (not shown) that produce wanted sounds as well as one or more noise generating devices (not shown), such as electronic devices (e.g., rack mount equipment) and HVAC system components (e.g., vents) that produce unwanted noise. That is, while the environment includes zero, one or more audio devices that produce wanted sound, the environment includes one or more sources of unwanted noise that users may want to reduce or otherwise acoustically treat. Accordingly, to identify such unwanted noise for subsequent treatment by one or more audio devices, the system in the environment 100 shown in FIG. 1 includes zero, one or more noise field map determining devices configured to periodically determine the location of such unwanted noise.

In certain embodiments, the noise field map determining system utilizes a beamforming microphone array 102 to periodically determine the location of such unwanted noise in the environment 100 independent of the source of such unwanted noise. That is, since the unwanted noise produced by certain distinct noise sources N1 104a, N2 104b and N3 104c can be diffuse and/or directional and the directional information of a specific sound source is often lost due to reverberation effects in a room, the noise field map determining devices of the system of this disclosure identify specific areas of unwanted noise rather than attempting to identify the location of the source of such unwanted noise.

Specifically, in certain embodiments, the system utilizes the beamforming microphone array 102 to map the noise field intensity in the environment relative to location to identify the location of any areas with an amount of unwanted noise that exceeds a threshold amount of unwanted noise. In operation of such embodiments, upon a noise field map determination triggering event, such as upon an occurrence of a set time of day, an occurrence of a set duration since a noise field map was previously determined and/or upon a determination that the environment is unoccupied, the beamforming microphone array 102 scans the environment 100. Such scanning includes the beamforming microphone array operating as a measurement tool by creating a beam and moving it around the environment to specified locations which are each associated with distinct coordinates. At these specified locations, the beamforming microphone array takes a room mean square (RMS) measurement of ambient noise and/or a power spectral density vs frequency measurement. Following such measurements, the beamforming microphone array attaches or otherwise associates the measures of a specified location to the distinct coordinates of that location. In certain embodiments, the system enables a user to specify the resolution at which the environment is characterized, wherein the resolution corresponds into a measurement time and available spatial resolution of areas of elevated levels of unwanted noise.

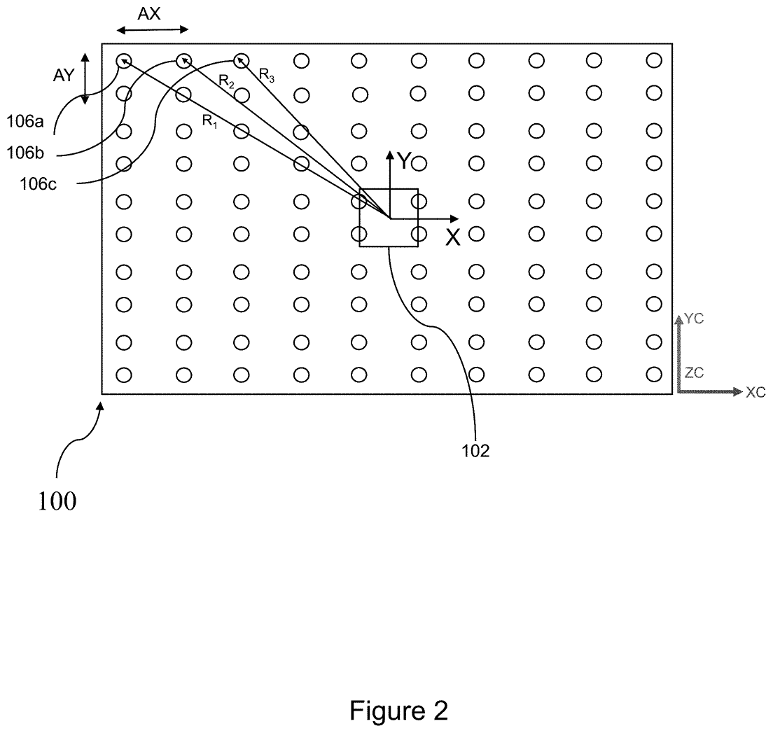

More specifically, in certain embodiments, during a period of minimal to no activity in the environment (i.e., to obtain a steady state noise field of an unoccupied space), as seen in FIG. 2, the system divides the environment into a plurality of measurement points 106a, 106b and 106c (i.e., spatial locations that are each tied to a particular coordinate set) and determines, at each measurement point, the RMS measurement of ambient noise at that point as:

$${R}_{N} ( X , Y , Z ) = ( \frac{L}{2} + \frac{Δ X}{2} + Δ X N ) , ( \frac{W}{2} + \frac{Δ Y}{2} + Δ YN ) , ( \frac{H}{2} + \frac{Δ Z}{2} + Δ ZN ) N = 0 , 1 , 2 … … \\ N ( {R}_{N} ( X , Y , Z ) ) = \sqrt{{\int }_{{f}_{0}}^{{f}_{1}} {\vert N ( f ) \vert}^{2} df}$$

Following the RMS measurement of ambient noise at the different spatial locations tied to the different coordinate sets (and/or following measurements of one or more features of sound such as volume, pressure level, frequency, duration and time of occurrence at the different spatial locations tied to the different coordinate sets), the system determines a noise field map that identifies areas of elevated stationary noise. Such a noise field map includes information about an amount of noise at each identified area of the environment as well as information about zero, one or more spectral characteristics of such noise.

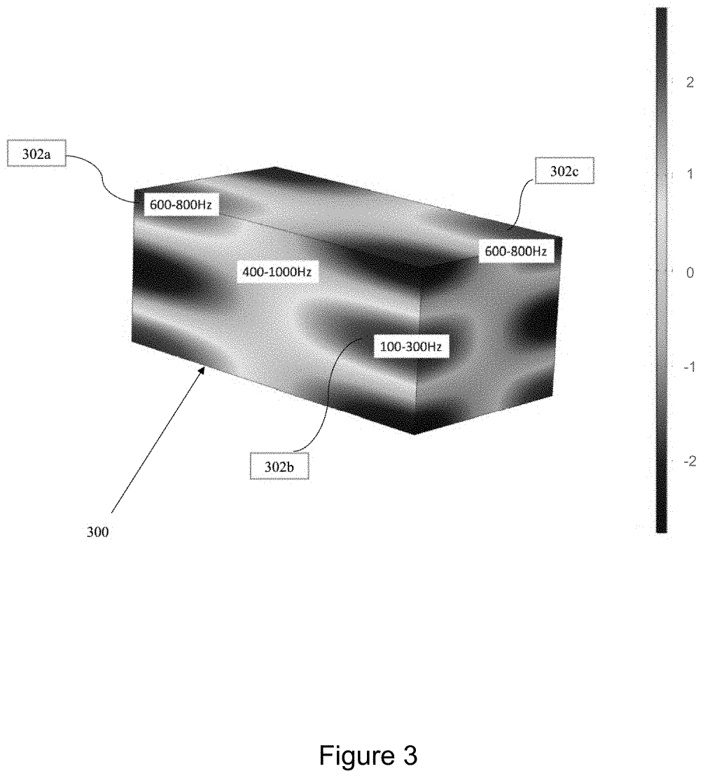

In one illustrated example, as seen in FIG. 3, the noise field map 300 includes the locations of unwanted pockets of noise 302a, 302b and 302c as well as the audio frequencies at the various locations. In this example, the determined noise field map identifies different areas of the environment associated with different noises having different frequency ranges. In certain embodiments, the determined noise field map additionally or alternatively contains 3^{rd} octave noise information to provide the system an understanding of noise maxima at each location.

In certain embodiments, the system causes a display device to display the determined noise field map. For example, if, as described below, the system utilizes the determined noise field map to provide a room designer or architect guidance on where to potentially place acoustical treatment devices, such as acoustic panels, the system causes a display device to display the determined noise field map. In other embodiments, the system does not display the determined noise field map but rather stores the data of the determined noise field map for subsequent analysis. For example, when the system utilizes the noise field map to automatically apply one or more digital signal processing techniques to the sound captured from an area of the environment identified as having an elevated amount of stationary noise, the system utilizes the data associated with the noise field map without causing any display of the noise field map.

In certain embodiments, in addition to or alternative from the noise field map determining system utilizing the beamforming microphone array to periodically determine the location of noise in an environment to determine a noise field map, the system employs a different audio device, such as a digital decibel meter, to periodically determine the location of noise in an environment to determine a noise field map. In certain other embodiments, rather than the noise field map determining system utilizing the beamforming microphone array (and/or one or more other audio devices) to periodically determine the location of noise in an environment to determine a noise field map, the system periodically receives data associated with a determined noise field map from one or more devices independent of the system.

Following the determination of the noise field map of a physical environment, the system employs the determined noise field map to modify, add and/or remove one or more components of the audio system of that physical environment. That is, upon determining a noise field map (or otherwise procuring a noise field map of a particular environment), the system proceeds to utilize that noise field map to modify the operation of one or more audio devices in the environment, facilitate the introduction of one or more audio devices into the environment and/or facilitate the removal of one or more audio devices from the environment.

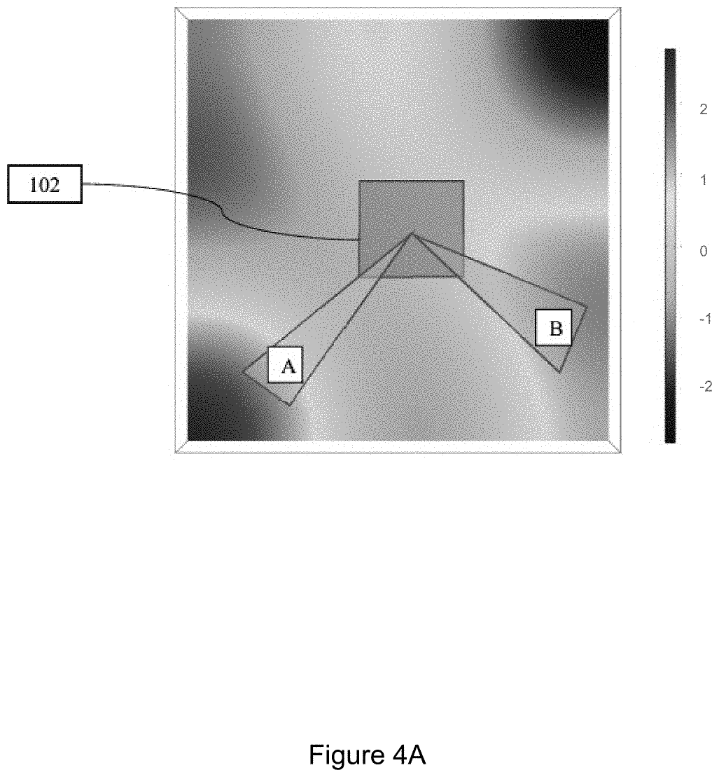

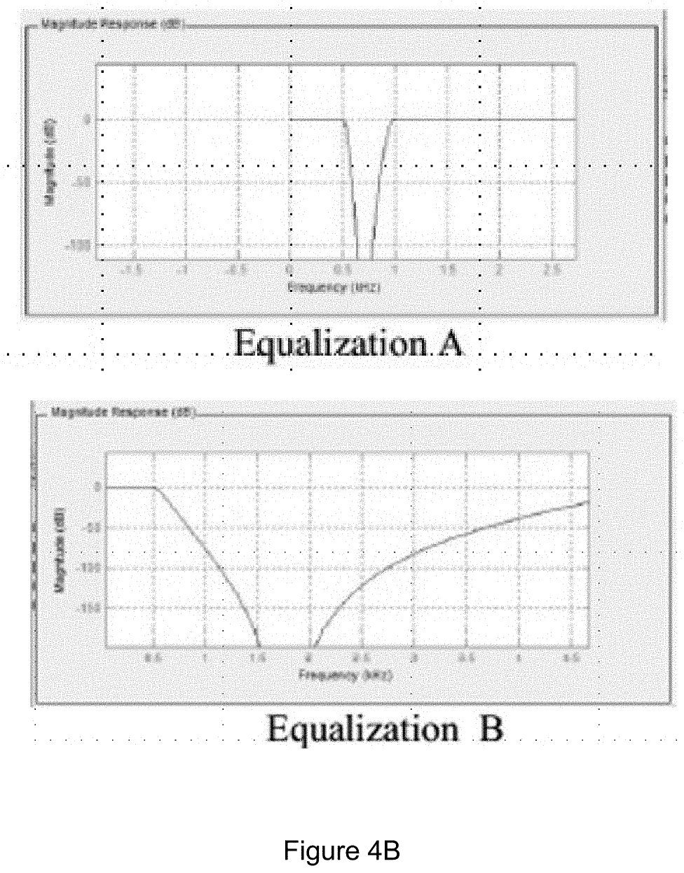

In certain embodiments wherein the system utilizes an audio device of the environment to determine the noise field map, the system modifies an operation of the same audio device based on the determined noise field map. For example, following the system employing a beamforming microphone array as a scanning device to determine a noise field map (as described above), the system employs the beamforming microphone array as a conferencing microphone wherein the system modifies operation of the beamforming microphone array based on the determined noise field map. In one such example, the modification of the operation of the beamforming microphone array includes applying one or more digital signal processing techniques to one or more lobes of the beamforming microphone array that are pointing at an area of the environment which the determined noise field map identifies as having an elevated amount of ambient noise. In this example, following a determination, via the noise field map, that an identified area of an environment has elevated noise such as noise in the range of 600 Hz to 800 Hz, the system modifies operation of the beamforming microphone array with a lobe pointed in that identified area by having an equalizing notch filter placed in that region to help reduce background noise, thus improving intelligibility. More specifically, as seen in FIG. 4 (which is a horizonal view of the environment taken at a Z location of an average talker's height), the environment includes various X/Y locations where lobes are pointed with relatively higher noise power (designated as areas A and B), wherein the system employs Equalization A to treat the unwanted noise in the 600 Hz to 800 Hz range, and further employs Equalization B to treat the unwanted noise in the 900 Hz to 2000 Hz range. In another example wherein the environment comprises a fixed seating area, the system designates an “audio keepout” section and causes the beamforming microphone array to cease from firing lobes in the general direction of the determined noise buildups in the environment with an aim of keeping users from occupying space with higher noise power. Accordingly, by accounting for specific areas of an environment with amounts of noise satisfying a criteria (and not trying to simply account for a source of unwanted noise), the system is operable to gain insight into areas of relatively poor intelligibility and apply preferential audio processing to such areas (via employing digital signal processing techniques and/or audio application software to treat wanted sounds and/or reduce unwanted noise) to improve a user's audio experience in the environment.

In certain embodiments wherein the system utilizes an audio device of the environment to determine the noise field map, the system modifies an operation of a different audio device based on the determined noise field map. In these embodiments, the different audio device comprises any suitable audio device for facilitating any suitable audio activity, such as, but not limited to, a conference call, a webcast, a telecast, a broadcast, a sound recording, a sound mixing, and/or audio post production. In such embodiments, based on the determined noise field map and the characterizations of the noise of the different areas of the scanned environment, the system modifies the use of one or more audio devices including, but not limited to, a microphone (e.g., a wired or wireless microphone), a speaker, a transceiver, a mixer, a transmitter, an audio router device, a computer (e.g. a desktop computer and/or a laptop computer), a mobile device (e.g., a smart phone), a tablet, a wearable device, and/or a smart appliance (e.g., a smart speaker). For example, following the system employing a beamforming microphone array as a scanning device to determine a noise field map (as described above), the system modifies operation of a speaker in the environment based on the determined noise field map. In this example, upon the system determining that a speaker is associated with an area of the environment that the determined noise field map identifies as having an elevated amount of ambient noise, the system modifies an operation of the speaker by decreasing (or increasing) an output of the speaker. Accordingly, by accounting for specific areas of an environment with amounts of noise satisfying a criteria (and not trying to simply account for a source of unwanted noise), the system is operable to gain insight into areas of relatively poor intelligibility and alter the operation of one or more audio devices to improve a user's audio experience in the environment.

In certain embodiments, regardless of the source of the noise field map, the system causes a display device to display the determined noise field map. For example, to provide a room designer or architect guidance on where to potentially place acoustical treatment devices, such as acoustic panels, acoustical tiles or diffusers to the structure on/around determined relatively high noise power locations, the system causes a display device to display the determined noise field map. Accordingly, by accounting for specific areas of an environment with amounts of noise satisfying a criteria (and not trying to simply account for a source of unwanted noise), the system enables personnel to gain insight into areas of relatively poor intelligibility and take necessary precautions to counteract such areas to improve a user's audio experience in the environment.

In certain embodiments, as indicated above, based on the determined noise field map, the system employs audio application software to deliver a software solution for digital signal processing (“DSP”) and other forms of audio analytics such as transcription, sound detection and classification, threat detection, and counting discrete speakers. In these embodiments, the audio application software is configured to receive audio data from an end user (e.g., audio data in any format either communicated directly from an audio device or uploaded from the audio device to an intermediary) and apply one or more audio processing functionalities to the audio data. The resulting processed audio data may be communicated back to the same audio device, communicated to a different audio device or hosted online for distribution/streaming. The audio application software offers an audio processing and production platform that provides users with efficient audio processing and production tools, such as, but not limited to, audio mixing capabilities for mixing audio data, audio mastering capabilities for mastering audio data, audio restoration capabilities for restoration of audio data, audio monitoring capabilities for monitoring audio data, loudness control capabilities for controlling loudness of audio data, audio decoding capabilities for decoding encoded audio data, audio encoding capabilities for encoding unencoded audio data, audio transcoding capabilities for transcoding encoded audio data from one form of coded representation to another, and metadata management capabilities for managing metadata associated with audio data.

In certain embodiments wherein the audio application software is associated with an audio conferencing system, the audio application software comprises a conferencing application that operates with computing resources to service at least the environment mapped for areas of ambient noise. For example, the computing resources can be either a dedicated resource, meaning its only intended use and purpose is for conference audio processing, or a shared resource, meaning it is also used for other in-room services, such as, e.g., a soft codec platform or document sharing. In either case, placing the software solution on a pre-existing computing resource lowers the overall cost and complexity of the conferencing platform of this example. The computing device can support network audio transport, USB, or other analog or digital audio inputs and outputs and thereby, enables the computing device (e.g., PC) to behave like DSP hardware and interface with audio devices and a hardware codec. The conferencing platform also has the ability to connect as a virtual audio device driver to third-party soft codecs (e.g., third-party conferencing software) running on the computing device. In one embodiment, the conferencing application utilizes C++ computer programing language to enable cross-platform development.

The conferencing application of this example embodiment may be flexible enough to accommodate very diverse deployment scenarios, from the most basic configuration where all software architecture components reside on a single laptop/desktop, smart phone, server, or web browser-based application, to becoming part of a larger client/server installation and being monitored and controlled by, for example, proprietary conferencing software or third-party controllers. In some embodiments, the conferencing application product may include server-side enterprise applications that support different users (e.g., clients) with different functionality sets. In these embodiments, remote status and error monitoring, as well as authentication of access to control, monitoring, and configuration settings, can also be provided by the conferencing application operating with the audio system middleware. Supported deployment platforms may include, for example, Windows 8 and 10, MAC OS X, etc.

The conferencing application of this example embodiment can run as a standalone component and be fully configurable to meet a user's needs via a user interface associated with the product. In some cases, the conferencing application may be licensed and sold as an independent conferencing product. In other cases, the conferencing application may be provided as part of a suite of independently deployable, modular services in which each service runs a unique process and communicates through a well-defined, lightweight mechanism to serve a single purpose.

In certain embodiments, the audio application software is associated with one or more indexed libraries for storing, sharing, and accessing different audio files. In different embodiments, the audio application software is associated with one or more audio suites for sound effects, one or more audio suites for noise reduction/noise suppression/noise cancellation, one or more libraries of other types of audio plugins, one or more audio libraries of audio sources, one or more audio libraries of audio processing algorithms (e.g., filtering, equalization, dynamic range control, reverberation, etc.), and one or more audio libraries of audio-related measurements.

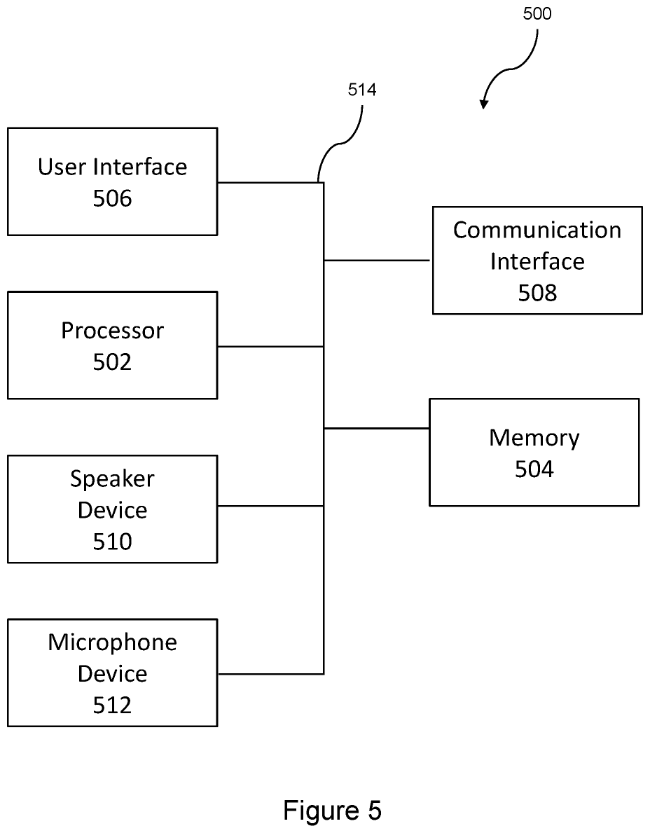

As described above, the audio system disclosed herein utilizes various components which operate to determine a noise field map of an environment and/or adjust operation based on a determined noise field map of the environment. Certain of these components utilize one or more computing devices to execute one or more functions or acts disclosed herein. FIG. 5 illustrates a simplified block diagram of an exemplary computing device 500 of the audio system disclosed herein.

The computing device 500 may include various components, including for example, a processor 502, memory 504, user interface 506, communication interface 508, speaker device 510, and microphone device 512, all communicatively coupled by system bus, network, or other connection mechanism 514. It should be understood that examples disclosed herein may refer to computing devices and/or systems having components that may or may not be physically located in proximity to each other. Certain embodiments may take the form of cloud based systems or devices, and the term “computing device” should be understood to include distributed systems and devices (such as those based on the cloud), as well as software, firmware, and other components configured to carry out one or more of the functions described herein. Further, as noted above, one or more features of the computing device 500 may be physically remote (e.g., a standalone microphone) and may be communicatively coupled to the computing device, via the communication interface 508, for example.

Processor 502 may include a general purpose processor (e.g., a microprocessor) and/or a special purpose processor (e.g., a digital signal processor (DSP)). Processor 504 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs).

The memory 504 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 504 includes multiple kinds of memory, particularly volatile memory and non-volatile memory.

The memory 504 may be computer readable media on which one or more sets of instructions, such as the software for operating the methods of the present disclosure can be embedded. The instructions may embody one or more of the methods or logic as described herein. As an example, the instructions can reside completely, or at least partially, within any one or more of the memory 504, the computer readable medium, and/or within the processor 502 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

User interface 506 may facilitate interaction with a user of the device. As such, user interface 506 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. The user interface 506 may also comprise devices that communicate with inputs or outputs, such as a short-range transceiver (RFID, Bluetooth, etc.), a telephonic interface, a cellular communication port, a router, or other types of network communication equipment. The user interface 506 may be internal to the computing device 500, or may be external and connected wirelessly or via connection cable, such as through a universal serial bus port.

Communication interface 508 may be configured to allow the device 500 to communicate with one or more devices (or systems) according to one or more protocols. In one example, the communication interface 508 may be a wired interface, such as an Ethernet interface or a high-definition serial-digital-interface (HD-SDI). As another example, the communication interface 308 may be a wireless interface, such as a cellular, Bluetooth, or WI-FI interface.

In some examples, communication interface 508 may enable the computing device 500 to transmit and receive information to/from one or more microphones and/or speakers. This can include lobe or pick-up pattern information, position information, orientation information, commands to adjust one or more characteristics of the microphone, and more.

Data bus 514 may include one or more wires, traces, or other mechanisms for communicatively coupling the processor 502, memory 504, user interface 506, communication interface 508, speaker 510, microphone 512, and or any other applicable computing device component.

In embodiments, the memory 504 stores one or more software programs for implementing or operating all or parts of the audio system platform described herein and/or methods or processes associated therewith. According to one aspect, a computer-implemented method of employing middleware to manage or facilitate the management of various features of an audio system can be implemented using one or more computing devices 300 and can include all or portions of the operations disclosed herein.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of operating an audio system, the method comprising:
determining, by a first audio device, an area of a room associated with an amount of noise satisfying a criteria,
characterizing a noise of the determined area of the room, and
modifying, based on the characterization of the noise of the determined area of the room, an operation of a component of a second audio device associated with the determined area of the room.

2. The method of claim 1, wherein the first audio device comprises a beamforming microphone array.

3. The method of claim 2, wherein the determination of the area of the room associated with the amount of noise satisfying the criteria comprises mapping, by the beamforming microphone array, a plurality of different areas of the room.

4. The method of claim 1, wherein the determination of the area of the room associated with the amount of noise satisfying the criteria occurs independent of any determination of any source of the noise.

5. The method of claim 1, wherein the characterization of the noise of the determined area of the room comprises determining a spectral characteristic of the noise.

6. The method of claim 1, wherein the second audio device comprises a digital signal processor and modifying the operation of the second audio device comprises causing the digital signal processor to apply a digital signal processing technique to the noise associated with the determined area of the room.

7. The method of claim 6, wherein the digital signal processing technique comprises an active noise cancellation process.

8. The method of claim 1, wherein the second audio device comprises a speaker and modifying the operation of the second audio device comprises causing the speaker to cease producing any sound associated with the determined area of the room.

9. The method of claim 1, wherein the second audio device comprises a display device and modifying the operation of the second audio device comprises causing the display device to display an indication of a location of the determined area of the room.

10. The method of claim 1, wherein the first audio device is different from the second audio device.

11. A method of operating an audio system, the method comprising:
determining a first configuration of an audio device associated with a room,
receiving data associated with a location in the room of an amount of ambient noise satisfying a criteria, and
modifying, based on the received data, the first configuration of the audio device to a second, different configuration.

12. The method of claim 11, wherein the audio device is selected from the group consisting of: a microphone, an audio transmitter, an audio receiver, an audio recorder, a speaker, an audio routing device, a digital signal processor and an audio mixer.

13. The method of claim 11, wherein the first configuration of the audio device is not associated with any digital signal processing of the ambient noise and the second, different configuration of the audio device is associated with a digital signal processing of the ambient noise.

14. The method of claim 11, wherein the first configuration of the audio device is associated with a first digital signal processing of the ambient noise and the second, different configuration of the audio device is associated with a second, different digital signal processing of the ambient noise.

15. The method of claim 11, wherein the first configuration of the audio device comprises a first mode of operation of the audio device and the second, different configuration comprises a second, different mode of operation of the audio device.

16. The method of claim 11, wherein the received data comprises a noise map of the room.

17. The method of claim 16, wherein the noise map of the room is created independent of identifying any source of any noise of the room.
